(19) United States
(12) Patent Application Publication
(10) Pub. No.: US 2011/0106349 A1
(43) Pub. Date: May 5, 2011

(54) Vehicle operated on electric highway

(76) Inventor: Masami Sakita, San Francisco, CA (US)

(21) Appl. No.: 12/589,924

(22) Filed: Oct. 30, 2009

(51) Int. Cl. G06F 7/00; B60K 1/00; B60M 1/00

(52) U.S. Cl. 701/22; 180/65.1; 191/22 C

(57) ABSTRACT

The vehicle operated in an electric highway system has an electric motor, at least one energy storage device, an on-board power pick up device, at least one coupler, at least one power meter, at least one on-board computer, an on-board part of a lateral location sensor, an on-board lateral position control mechanism, a longitudinal distance/speed sensor, and a longitudinal position control mechanism, and at least one communication device. The vehicle is able to operate and couple together with other vehicles automatically in the electrified lane of the electric highway system.

### FIELD OF THE INVENTION

This invention relates generally to vehicles operated on electric highways.

### BACKGROUND OF THE INVENTION

Electric power has been used to energize vehicles operated on the highway for a long time as seen in the trolley bus on the city street. The trolley bus is quiet, does not emit exhaust gas, and its current collection (or power transfer) method that uses the current collector poles and the overhead wires is very energy efficient. This current collection method, however, is neither designed for high speed operations nor applicable to the ordinary automobile.

The electrified highway that does not use direct electrical conductive connection was tested in 1990 by the PATH (California Partners for Advanced Transit and Highways) administered at the Institute of Transportation Studies of the University of California at Berkeley in collaboration with Caltrans of the State of California. In the PATH experiment, electric power was supplied to the test vehicle (an electric bus) by electromagnetic induction system that includes an iron core in both primary and secondary conductors. It is reported that the overall system efficiency was about 60%, but the PATH researchers believed that the efficiency can be improved by 10 to 20%.

Independently, Boys et al at UniServices of the University of Auckland developed a power transfer system by induction called the IPT (Inductive Power Transfer) that uses primary conductors with no cores and secondary conductor with a ferrite core carrying resonant current in the order of 10 kHz (see U.S. Pat. Nos. 5,293,308, 5,528,113 and 5,619,078 μl by Boys et al). The technology developed by Boys et al is widely used for transporting vehicles in the assembly line for automobile manufacturing plants and transporting cargos in warehouses. These systems use a primary conductor comprising a series of alternating litz wire pairs and resonating capacitors, and a secondary conductor wound around a ferrite core and a resonating capacitor underneath the vehicle. A light rail system developed by Bombardier Transportation GmbH that uses seemingly a similar technology as that developed by Boys et al is reported to be on the market by 2010.

The electromagnetic induction power transfer is definitely a more suitable power transfer method in energizing vehicles on the highway than that uses the overhead wires because it can be used with all types of vehicles tall and short. In addition, not having the overhead wires is more aesthetically pleasing. According to a Bombardier brochure, its Primove light rail system equipped with Mitrac Energy Saver regenerative braking system is energy efficient, and is designed to provide 250 kW of continuous power output for a typical 30 m long rail vehicle, and performance can vary from 100 kW to 500 kW depending on the length and number of vehicles, topographic conditions and range of application. We believe that this indicates that there is a good possibility that the same electromagnetic induction power transfer technology may be used as a means to energize automobiles operated on the highway.

The electromagnetic induction power transfer system, however, probably will be more expensive to build, and more susceptible to failures than that uses the overhead wires, and when failed, could be more time consuming to repair. Thus we have developed an electric highway system design that uses a new induction power transfer type roadside conductor assembly that may be inexpensively built and easily repaired, and a new system configuration that includes a centralized system monitoring facility for monitoring system operation and overseeing system failure repair operations. The new design is described in the specification of a co-pending US patent application. The system can be a hybrid system between that uses the inductive power transfer system for ordinary automobiles and that uses the overhead wire system for large trucks and buses. The vehicle of the present invention is that used in the proposed electric highway system.

### OBJECTS OF THE INVENTION

An object of this invention is the provision of a vehicle operated in an electric highway system safely with much shorter headways than the conventional vehicle can.

In order to achieve the object, the vehicle operated in the electric highway is equipped with at least one coupler for physically coupling vehicles, and lateral and longitudinal position control means that enable automatic operation of coupled vehicles in the electrified lane. The idea of automatically operating coupled vehicles is an extension of the idea of the automated platoon operation of vehicles demonstrated in the real-world experiments by the PATH in cooperation with General Motors and its various subsidiaries in 1997. Much of the work done in the PATH project in lateral/longitudinal vehicle control should be applicable to lateral/longitudinal vehicle control of the vehicles in the electric highway system described in this specification also. In these experiments the PATH researchers found that vehicles traveling in a tight, automated platoon with about half a vehicle interval have a dramatic reduction in aerodynamic drag that results in a 20 to 25-percent improvement in fuel economy and emission reduction.

Coupled operation of a string of vehicles should be able to achieve similar or even better effects in terms of improvements in energy use. The vehicle that is equipped with a regenerative braking means as done with most hybrid vehicles should be able to save possibly another 10 to 30 percent of energy in addition to the 20 to 25 percent improvements through coupling. Coupled operation of a string of vehicles should also lead to a few times higher capacity per electrified lane, and this higher capacity in turn should lead to less or no congestion and less need for construction of new highways, and these should result in even higher energy savings and CO2 reduction. In addition, the automated operation of coupled vehicles operated in an electric highway system that is closely monitored and rigorously controlled as in the proposed system should greatly reduce the possibilities of accidents in the electrified lane.

### SUMMARY OF THE INVENTION

The electric highway system in which the preferred embodiment of the vehicle of the present invention is operated includes a roadside subsystem; a centralized system operation monitoring center; an account processing center that may be located in the same facility as the system operation monitoring center; a roadside part of a lateral location sensor; a communication network that connects the system operation monitoring center, the account processing center and the roadside subsystem; at least one electrified lane; at least one power source such as a feeder station; and power cables that connect the power source and the roadside subsystem.

The roadside subsystem includes a plurality of roadside conductor assemblies, each of which includes at least one roadside conductor longitudinally disposed in the traffic lane; a plurality of roadside controllers housed in a roadside box wherein which controller includes a power supply assembly to the roadside conductor, and at least one communication means; a plurality of roadside posts with a camera affixed to it.

The preferred embodiment of the vehicle includes an electric motor, at least one energy storage means, an on-board power pick up means assembly, at least one coupler, a power meter, at least one on-board computer, an on-board part of a lateral location sensor, an on-board lateral position control means, a longitudinal distance/speed sensor, a longitudinal sensor, a longitudinal position control means, and at least one communication means.

The coupler is retractable, and includes a pair of snubber assemblies each of which assemblies includes a coupling means. The coupling means is rotatably slidably affixed to the outer end (or the front end in the front coupler and the rear end in the rear coupler) of a snubber rod whose longitudinal middle part's outer wall has threads that mesh with internal threads of a bearing, which is slidably received by a cylindrical housing of the snubber that is affixed to the frame of the vehicle. Longitudinal movement of the bearing is restricted by a pair of coil springs each of which is disposed between the front/rear end of the bearing and the front/rear end wall of the snubber.

### BRIEF DESCRIPTION OF THE DRAWINGS

The above description and other objects and advantages of this invention will become more clearly understood from the following description when considered with the accompanying drawings. It should be understood that the drawings are for purposes of illustration only and not by way of limitation of the invention. In the drawings, like reference characters refer to the same parts in the several views:

FIG. 1 is a schematic representation of an electric highway in which the vehicle of the present invention is operated;

FIG. 2 is a rear view of a roadside conductor assembly, a vehicle equipped with an on-board power pick up means assembly, and a roadside post;

FIG. 3A is a cross-sectional view of a front coupler in the contracted state, and 3B a side view of the front coupler in the expanded state;

FIG. 4A is a front view and FIG. 4B a cross-sectional view of the front coupler and a cross-sectional view of the coupling means of the rear coupler;

FIG. 5A is a front view, 5B a side view, 5C a bottom view in the retracted state and 5D in the extended state of a coupler of an alternative embodiment;

FIG. 6A is a cross-sectional view of the couplers of an alternative embodiment of two vehicles before coupling, 6B while in the coupled state, and 6C after the following vehicle has taken decoupling action;

FIG. 7A is a side view, FIG. 7B a top view, and FIG. 7C a front view of an alternative embodiment of the on-board power pick up means assembly;

FIG. 8 is a rear view of a truck equipped with an alternative embodiment of the power pick up means that uses a special-design pantograph assembly, and a roadside post;

FIG. 9 is a side view of a truck equipped with the pantograph assembly and a roadside post;

FIG. 10A is the folded state and FIG. 10D the un-folded state of the alternative embodiment of the power pick up means, and FIGS. 10B and 10C between the two states; and

FIG. 11A is a partial front view, 10B a partial top view, and 10C a partial side view of the pantograph assembly.

### DETAILED DESCRIPTION OF THE INVENTION

### Preferred Embodiment

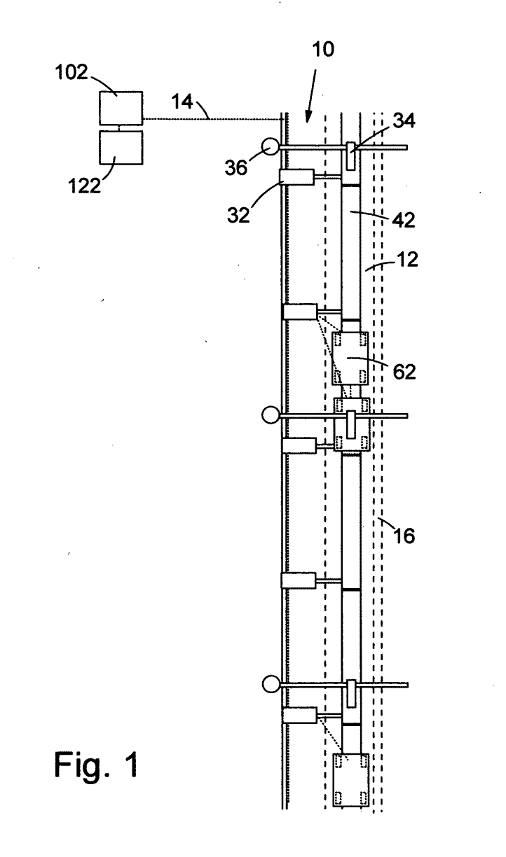

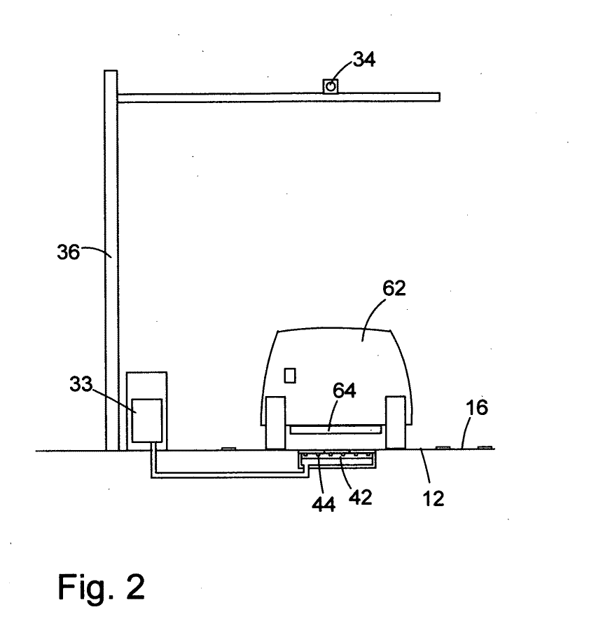

As shown in FIGS. 1 and 2, the electric highway system, in which the preferred embodiment of the vehicle 62 of the present invention is operated includes a roadside subsystem 10, a centralized system operation monitoring center 102 and an account processing center 122 that may be located in the same facility as the system operation monitoring center, a communication network 14 that connects the system operation monitoring center, the account processing center and the roadside subsystem, at least one electrified lane 12 that may be separated from the ordinary traffic lanes by a non-elevated divider strip 16 between them in a partially electrified highway, at least one power source such as a feeder station, and power cables that connect the power source and the roadside subsystem.

The roadside subsystem 10 includes a plurality of roadside conductor assemblies 42 disposed longitudinally serially in the electrified lane, each of which conductor assemblies includes at least one roadside conductor 44; a plurality of roadside controllers 33 each housed in a roadside box 32 wherein which controller includes a power supply to the roadside conductor 44, a power meter, a power switch to the roadside conductors, and at least one communication means; a plurality of roadside posts 36 with a camera 34 affixed to it; and a roadside part of a lateral location sensor.

The electrified lane 12 is used by a plurality of vehicles 62 equipped with an on-board power pick up means assembly 64, an electric motor, at least one energy storage means, a power meter, at least one coupler, at least one on-board computer, an on-board part of a lateral location sensor, a lateral position control means, a longitudinal distance/speed sensor, a longitudinal position control means, and at least one communication means.

The on-board power pick up means assembly includes a power pick up means with a capacitor. The power pick up means affixed to the bottom of the vehicle according to Boys et al includes a plurality of coils wound around a generally plate-shaped core in such a manner that each of the coils will pass directly above a roadside conductor while the vehicle runs in the electrified lane.

When the vehicle 62 passes by the roadside box 32, the vehicle receives a signal requesting for payment information from the roadside controller. The vehicle that is running in the electrified lane or that is ready to change lanes into the electrified lane transmits the payment information. If the vehicle transmits valid payment information including the vehicle ID, on-board power meter reading, account number, etc., the roadside controller, will switch on the roadside conductors if they have not yet been switched on, and will transmit back to the vehicle the power charge information including date, time, vehicle ID, roadside box ID, the on-board power meter reading, etc. in return. The means and method similar to that used in the toll payment system that uses an RFID technology may be used for this purpose.

Together with the payment information, or independently, the vehicle sends current speed and acceleration/deceleration rate to the roadside controller. In return, the roadside controller transmits the allowable maximum speed to the vehicle that has been determined by the system operation monitoring center. The roadside controller transmits the information from the vehicle together with its roadside box ID to the system operation monitoring center.

The electric highway and the vehicle of this invention may use a lateral location sensing technology developed by the PATH. The on-board part of the lateral location sensor is at least one pair of magnetometers affixed to the front end and possibly at least one pair of magnetometers affixed to the rear end of the vehicle symmetrically arranged about the vehicle's centerline and faced generally outward. The roadside part of the lateral location sensor is a plurality of magnetic cells placed in drilled holes in the pavement along the lane markings of the electrified lane with generally equal longitudinal spacing. The on-board part of the lateral location sensor estimates the amount of deviation of the lateral center of the vehicle at the front end and possibly the rear end from the centerline of the electrified lane, wherein the estimation of deviation is based on observed correlation between the normalized difference of the strengths of the magnetic fields in a (right/left) pair of magnetometers and actual deviation of the center point of the vehicle from the centerline of the electrified lane.

The lateral position control means includes a computer-controller means to rotate the steering wheel shaft. While in the electrified lane, the on-board computer computes the amount of rotational angle the motor should make based on the deviation of the front center point and possibly the rear center point of the vehicle from the imaginary centerline of the electrified lane. The lateral position control means should be able to steer the vehicle in such a manner that the center point of the vehicle at the front end and possibly at the rear end will coincide with the imaginary center line of the electrified lane.

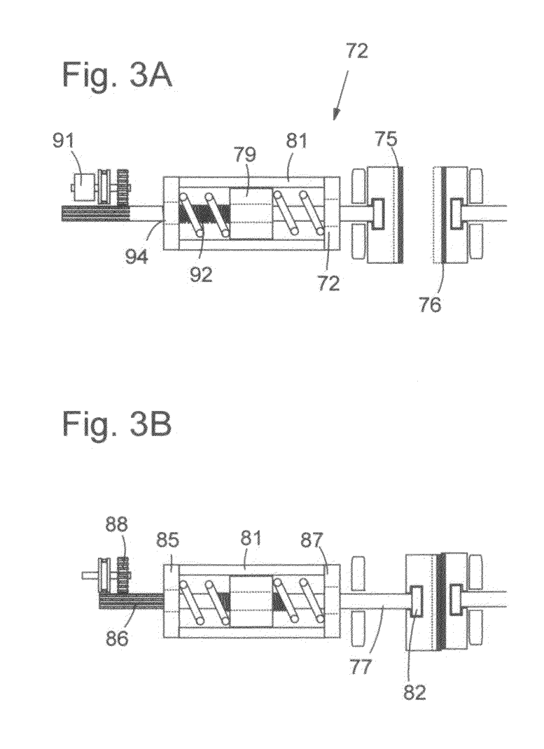

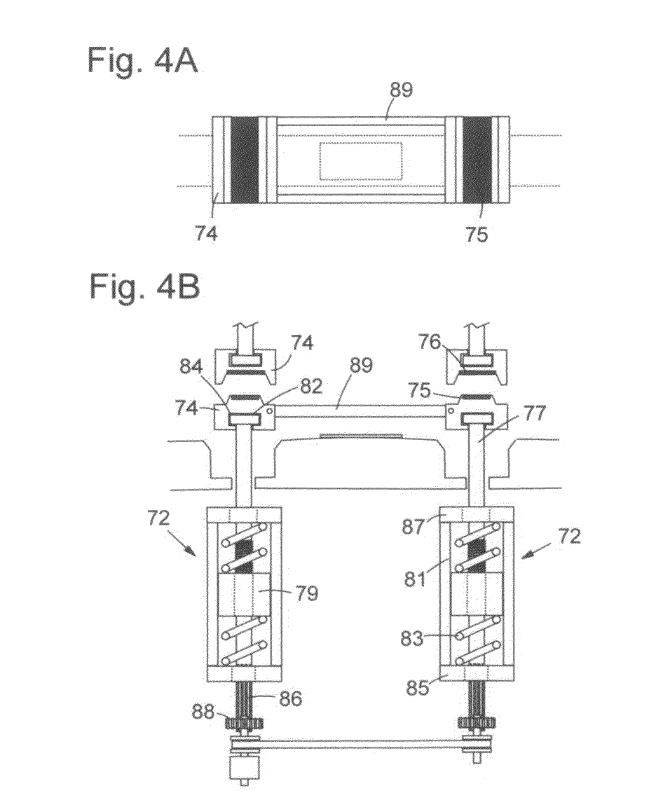

The vehicle is equipped with a front and/or rear coupler that are/is retractable (see FIGS. 3A, 3B, 4A and 4B). The front coupler includes a pair of snubber assemblies 72 each of which assemblies includes a coupling means 74 with a protruded contact surface 75, and the rear coupler includes a pair of snubber assemblies each of which assemblies includes a coupling means with an indented contact surface 76.

The coupling means 74 is rotatably slidably affixed to the outer end (or front end) of a snubber rod 77 whose outer wall of the longitudinal middle part of the snubber rod has threads that mesh with internal threads of a bearing 79, which is slidably received by a cylindrical housing 81 of the snubber that is affixed to the frame of the vehicle. Longitudinal movement of the bearing is restricted by a pair of coil springs 83 each of which disposed between the front or rear end of the bearing and the inner end wall 87 (front wall in the front coupler) or the inner end wall 85 (or the rear wall) of the snubber. The inner end wall 85 of the snubber has an internal thread that meshes with the thread of the snubber rod's outer wall under the contracted state of the coupler, and the outer end wall 87 has a cylindrical hole through which the snubber rod penetrates. The coupling means of the pair of snubber assemblies are connected together by a connecting means 89 and pins 99.

The snubber rod 77 has a rotationally-slidable cylindrical boss 82 enclosed in a cylindrically shaped socket in one end, and gear teeth 86 on the outer cylindrical wall of the snubber rod in the other end. The gear teeth 86 of the snubber rod meshes with a gear 88 that is affixed to or rotatably connected to the rotational shaft of a motor 91. As the motor 91 rotate, the coupler extends, and the thread 92 of the snubber rod's outer wall finish meshing with the internal thread 94 of the inner end wall of the snubber, and thus under the extended state, the snubber rod is solely supported by the bearing through meshing of the threads. Under the extended state, the coupling means 74 and the snubber rod 77 is longitudinally movable as much as the springs 83 allow; the coupling means 74 is slidable laterally within a limited amount against the coupling means of the other coupler to which the “present” coupler is coupled with as the contact surface 76 of the rear coupler is wider than the contact surface 75 of the front coupler; and the coupling means 74 is vertically slidable against the coupling means of the other coupler to which the “present” coupler is coupled with.

The contact surface 75 of the coupling means 74 is magnetized electrically by a solenoid. The magnetic poles of the coupling means of the front and rear couplers are opposite to each other while the couplers are in the coupled mode so that the coupling means of the front and rear couplers will attract each other. The magnetic pole will be reversed by the vehicle that decides to decouple from the other vehicle. The coupling means could be replaced by a suction cup connected to an air compressor. Alternatively, the rear coupler may be of such a design that is equipped only with the coupling means affixed to the body of the vehicle directly.

The coupler will have three to-be-standardized coupler heights and possibly sizes: the highest and possibly largest coupler for large trucks, the medium height and possibly medium size coupler for SUVs and medium size trucks, and the lowest and possibly smallest coupler for passenger cars. Alternatively, at least the car, the SUV and the medium size truck may use the same coupler height and size so that they can couple together. The purpose of the coupler is to physically connect the vehicles so that a series of vehicles in a platoon will not collide to one another in case of an accident, and thus the magnetic field created by the solenoid does not have to be strong enough to pull the following vehicle.

While driving in the ordinary highway lane next to the electrified lane, if the driver wants to get into the electrified lane, and if he/she wants the vehicle to be couplable (or able to couple) to other vehicles, he/she presses “Automatic-Couplable” button on the dashboard when he/she finds the vehicle of the same coupler height/size with extended coupler in the electrified lane, and if he/she wants the vehicle to be non-couplable, he/she presses “Automatic-Non-Couplable” button on the dashboard of the vehicle. The vehicle will transmit the payment information to the nearest roadside box including the vehicle ID and a digital certificate that shows diagnostics results generated by the on-board computer to prove that the vehicle is in good condition for driving in the automatic mode in the electrified lane. When the roadside controller approves the use of the electrified lane, the vehicle will exchange with its to-be-leading vehicle and to-be-following vehicle their GPS coordinate readings, for example, those of WAAS (Wide Area Augmentation System), operating speeds and acceleration/deceleration rates, the coupler heights, and whether the to-be-leading vehicle and the “present” vehicle (or the vehicle being focused on) are couplable, wherein the vehicle is “couplable” implies that the vehicle is equipped with at least one coupler and is willing to couple.

If the on-board computer of the “present” vehicle determines it is safe to change lane into the electrified lane, it will permit the driver to change lane into the electrified lane. The vehicle will activate the lateral location sensor, the longitudinal sensor, the on-board lateral and longitudinal position control means generally as soon as the vehicle gets into the electrified lane, and the operational status indication will change to “Automatic Couplable” or “Automatic Non-Couplable” on the dashboard auto/manual status indicator. The longitudinal sensor measures the distance between the “present” vehicle and the vehicle immediately ahead (or a leading vehicle) of it continually every small time increment. The computer-controlled longitudinal position control means regulates the amount of power flows into the motor every small time increment to achieve necessary acceleration/deceleration rate. It is prohibited for the driver of the vehicle to control his/her vehicle within the electrified lane.

If the vehicle could not show valid payment information or a valid certificate, the roadside controller may transmit a signal (to the vehicle) that would temporarily switch off the vehicle's vehicle-to-vehicle communications capability until the problem is fixed (with such a warning to the vehicle), and also transmits the vehicle ID to the system operation monitoring center.

Note that in any two vehicles running in series in the same lane, the vehicle that is ahead of the other vehicle is called the leading vehicle, and the vehicle behind the leading vehicle is called the following vehicle regardless of the distance between them. When a string of vehicles is running in a platoon or coupled together, the first vehicle of the string is called the primary leading vehicle.

The longitudinal position control process of the “present” vehicle that is following a vehicle to which the “present” vehicle will be couplable comprises three parts: the first part begins when the vehicle enters into the electrified highway lane and ends when it enters into a catching up mode operation. The second part begins when, the catching up mode operation starts (this may occur when a vehicle changes lane into the electrified lane in front of the “present” vehicle while it is in the first part), and ends when the vehicle is coupled with the leading vehicle. The third part begins as the vehicle is coupled with the leading vehicle, and ends when the vehicle is decoupled from the leading vehicle to leave the electrified lane.

In the first part of operation, the vehicle's acceleration/deceleration rate may be constant till it reaches a predefined target speed, and the amount of power used for driving the motor is that is able to attain the acceleration/deceleration rate. In the second part of operation, in which the “present” vehicle is within the catch-up distance, the amount of power the vehicle will use (or braking applied) for driving the motor is determined in such a manner that the “present” vehicle will be able to attain a specified acceleration/deceleration rate of the “present” vehicle relative to the acceleration/deceleration rate of the leading vehicle wherein the specified acceleration/deceleration rate may be a expressed as a function of the leading vehicle's speed, acceleration/deceleration rate and the distance between the leading vehicle and the “present” vehicle.

In the coupled operation, the on-board computer of the “present” vehicle that is the last vehicle in a string of vehicles following a primary leading vehicle will adjust the amount of power used by the motor in such a manner that the distance between the “present” vehicle and the primary leading vehicle will be that equals the cumulative length of the vehicles in the string of vehicles plus the sum of the deviation-free coupler lengths of neighboring vehicles. In order to achieve this, every vehicle in the string is notified from the vehicles ahead of it the deviation-free coupler lengths and actual lengths of vehicles ahead of it at the time of coupling, and the sum of the actual deviation of the couplers on an on-line real-time basis every small time increment continuously. In a segment with a steep slope in which maintaining a constant distance between vehicles is not possible for a vehicle, the vehicle will have to decouple from the leading vehicle.

If the driver of a coupled vehicle in the middle of a string of vehicles wants to leave the electrified lane, he/she will press the “Decouple” button on the dashboard. The on-board computer of the vehicle will unlock the couplers and retract them, and will transmit a “want to decouple” message to the vehicles in the group. Then, the vehicle that is immediately behind the decoupling vehicle will become the primary leading vehicle of the second half of the group of vehicles. The driver of the decoupling vehicle will manually drive the vehicle out of the electrified lane. In this process, the decoupling vehicle will maintain communication link with its leading and following vehicles. The driver of the first vehicle of the second half of the group is on the automatic longitudinal control, and will not take any action.

If the leading vehicle and the “present” vehicle are not couplable, the “present” vehicle will have to be operated (automatically by the on-board computer) in the car following mode that mimics the manually driven vehicle that follows the leading vehicle. In the manually driven vehicle, the acceleration/deceleration rate of the following vehicle (or “present” vehicle) is determined by the leading vehicle's speed, the acceleration/deceleration rate and the distance between the leading vehicle and the following vehicle, and the driver's perception and reaction time. In the automated car following mode operation, a much shorter “perception and reaction time” is used, and then the acceleration/deceleration rate is determined such that the resultant driving behavior will become similar to that of the human driving. The amount of power used for driving the motor is the amount needed to attain the acceleration/deceleration rate.

It must be apparent that the amount of power used to drive the motor will have to be regulated every small time increment continuously in all these three parts of the vehicle operation.

The number of vehicles coupled together may have to be limited, for example, to 10. The reasons for this are two folds: one is that the larger the number (of vehicles coupled together) the larger the cumulative deviation of the couplers (from the deviation-free point) will become, and thus, at a certain point (or number of vehicles) the operation will become infeasible, and the other is that the growth in effectiveness diminishes as the number of vehicles in the string increases. The former should be obvious, and on the latter simplified estimation shows that, for example, if all vehicles are operated in coupled operation in a string of vehicles, and every string (of vehicles) is 2-vehicle long, the lane capacity will be approximately 1.8 times that of the ordinary lane capacity, and similarly, if every string is 3-vehicle long, the lane capacity will be approximately 2.3 times that of the ordinary lane capacity. In this manner, if every string is 5-vehicle long, the lane capacity will be 3.2 times, and if every string is 8-vehicle long, the lane capacity will be 4.0 times that of the ordinary lane capacity, and so on. The lane capacity grows as the size of the string increases, but its growth rate or the marginal effectiveness diminishes as the size of the string increases. In reality, limiting the maximum number of vehicles in a string to 10 will result in the average string length less than 10.

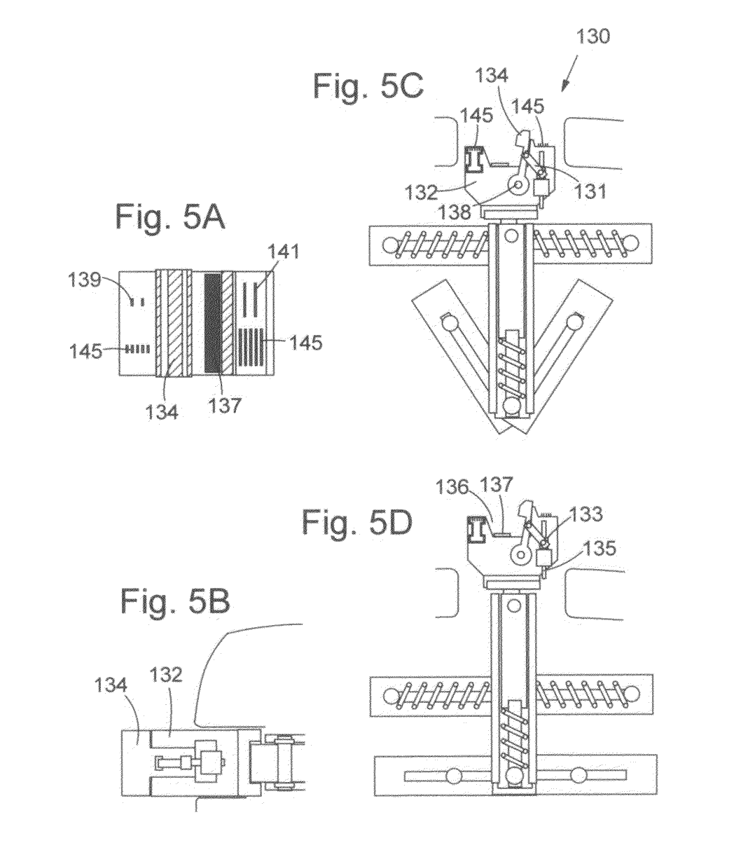

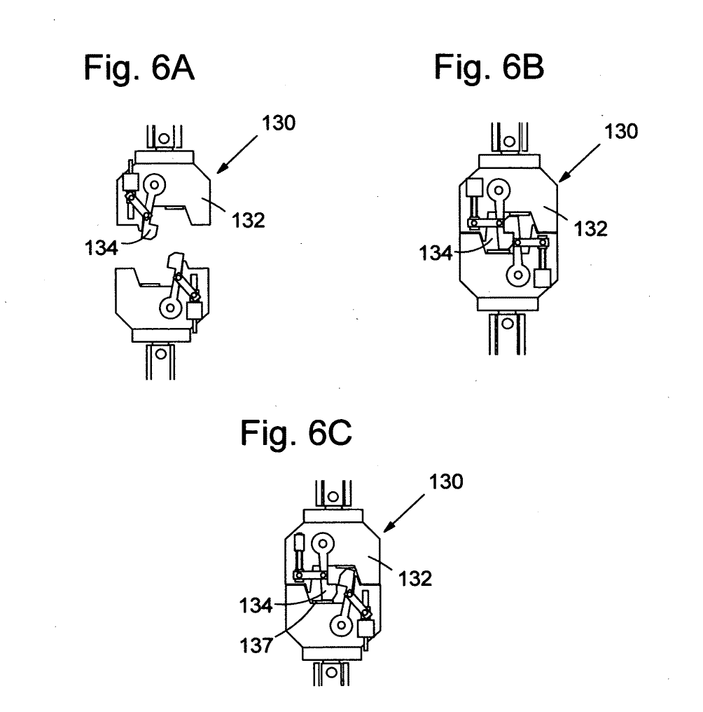

As FIGS. 5A through 5D and FIGS. 6A through 6C show, a coupler 130 of an alternative design has a mechanical coupling means. The coupler is also a retractable type having a housing 132 that encloses a coupling hook means 134 and a coupling hook receiving bay 136 disposed side by side. This coupler physically resembles a popular European rail coupler called Scharfenberg coupler. The coupling hook means 134 is narrower at the tip, and is pivotably affixed to a pin 138 and is made pivotable (or able to pivot) by a control means that includes a control arm 131 and a control rod 133. As a pneumatic actuator 135 extends and contracts the control rod 133, it pushes and pulls the control arm 131. The coupling hook receiving bay 136 is wider at the opening end for easier entry of the hook means of the coupler, and has a switch 137 at the deepest end from the opening. During the coupling process, as soon as the tip of the hook means of one coupler hits the switch, the actuator is activated and the hook means of the receiving coupler pivots toward the center of the coupler. Coupling is completed as the hook means of both couplers lock them together.

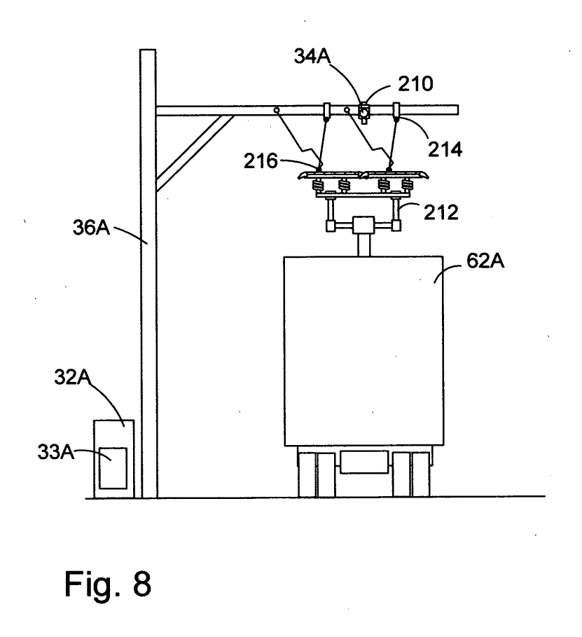

This coupler also has the three to-be-standardized coupler heights and sizes as with that used in the preferred embodiment. The coupler is spring loaded laterally and longitudinally, and is movable in these directions within a limited range. The front surface of the coupler has connection means 139 and 141 for communication cables, and connection means 143 and 145 of power lines of power lines in the other (see FIG. 8A). The coupling means is able to slide vertically while the vehicle is coupled to another vehicle, and thus the connecting means too will be made slidable vertically.

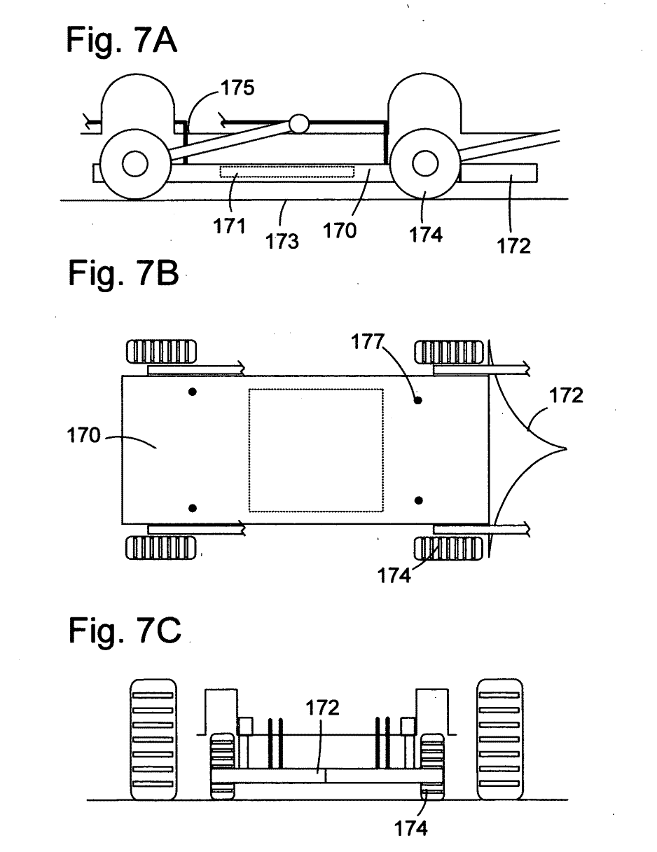

As shown in FIGS. 7A, 7B and 7C, an alternative embodiment of the power pick up means assembly 170 is equipped with a power pick up means 171; a debris-sweeping means 172 that sweeps debris that is generally taller than the height of the bottom surface of the power pick up means; and a computer-operated motorized lifting mechanism 177 that automatically lowers the power pick up means assembly from the bottom surface of the vehicle 175 closer to the road surface 173 when the vehicle moves into the electrified lane, and lifts it up when the vehicle moves out of the electrified lane. Wheels 174 may be added to keep the distance between the bottom surface of the pick up means and the road surface constant. A lowering mechanism of the power pick up means is shown in an electric highway concept developed by the PATH, and another lowering mechanism is also found in an electric mini bus operated in Genoa, Porto Antico. The lowering mechanism in the mini bus in Genoa, Porto Antico is used to charge the on-board battery at the battery charging station developed by Conductix-Wampfler AG.

### Alternative Embodiment A

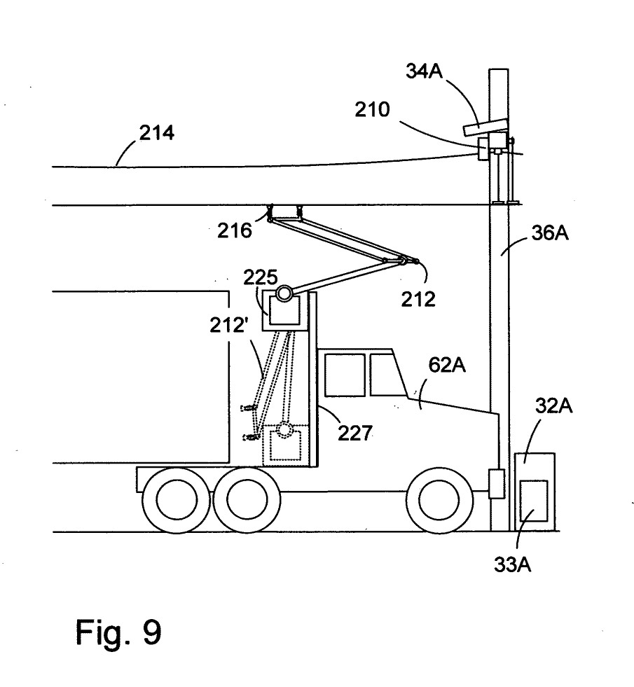

As shown in FIGS. 8 and 9, the vehicle 62A of this alternative embodiment is a tall vehicle equipped with a power pick up means assembly that is a roof-top pantograph assembly 212. The coupler may be of the mechanical coupling means type 130 shown in FIGS. 5A through 5D and FIGS. 6A through FIG. 6C with male and female connecting means of litz power cables and connecting means of communication lines.

The roadside conductor assembly 42A includes a pair of catenary assemblies per electrified lane, wherein each of which pair includes a catenary 214 (or messenger wire) and a contact wire 216 that transfers electric power to the vehicles in the electrified lane(s). The roadside post 36A includes a vertical member (a pole) and a horizontal member from which horizontal member a segment of at least one pair of catenary assemblies is hung, and on which horizontal member a transducer type detector 210 and the camera 34A are mounted.

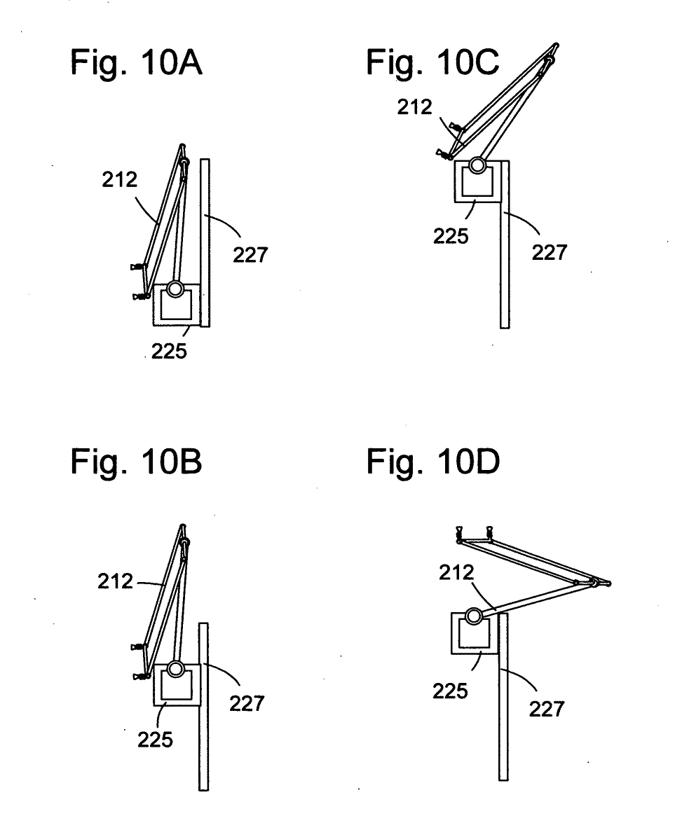

As shown in FIGS. 10A through 10D, the power pick up means assembly of the alternative embodiment, which is a pantograph assembly 212 of a special design and is affixed to a base means 225 that moves up and down a support frame 227 behind the driver's cab. When the pantograph assembly is in use as shown in FIG. 10D, the base means 225 is at the top of the support frame and the pantograph is unfolded, and when it is not in use as shown in FIG. 10A and FIG. 9, the pantograph assembly 212 is lifted down by the motor and folded down, and kept behind the driver cab (see 212′ in FIG. 9).

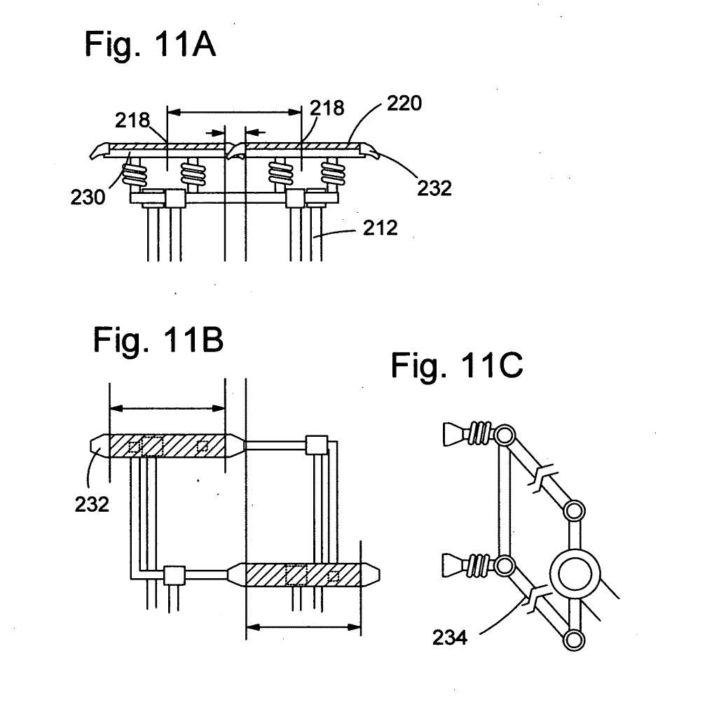

As shown in FIG. 9, FIGS. 10A through 10D, FIGS. 11A through 11C, pantograph assembly 212 comprises a pair of sliding means 220, each of which sliding means slidably contacts one of the contact wires 216; a pair of carriers 230 made of a non-conductive material to which top surface the sliding means is affixed; two pairs of horns 232 made of a non-conductive material each of which horn is affixed to each side of the carriers; a support frame assembly 234 to which the carriers are affixed; a pantograph beam assembly affixed to the support frame assembly at the one end and affixed to the roof of the vehicle at the other end. The pantograph assembly 212 is able to keep the pair of sliding means 220 surfaces generally on the same level plane even when the contact wires 216 are not touching them. The two sliding means have a lateral gap so that even if a contact wire falls lower than the normal level by accident, it will not touch the two sliding means at the same time. The two sliding means 220 are generally of the same length, which is shorter than the spacing between the two contact wires so that either of the sliding means will not touch the two contact wires at the same time. Each of the sliding means is connected to an electric wire and one of the wires is connected to the power meter before the wired is connected to any electric device in the vehicle.

The payment process is generally identical to that of the preferred embodiment except that the vehicle of third type takes electricity through the coupler. When the vehicle in the electrified lane passes by the roadside box 32A, the vehicle transmits its current speed, acceleration/deceleration rate to the roadside controller, and in return, the roadside controller transmits the allowable maximum speed to the vehicle. Independently of this, the roadside controller 33A creates a vehicle profile for every vehicle passed under the transducer type detector 210. In order to create a vehicle profile, a transducer type detector is mounted on the horizontal member of the roadside post. The detector emits a electromagnetic signal vertically downward and measures the echoing time it takes to return to the detector continuously, and thus it is able to draw a profile of every vehicle passing beneath the detector, and is able to predict whether the vehicle is equipped with the pantograph, whether the pantograph at the lifted-up state, or whether the vehicle is coupled.

The vehicle that it is not equipped with the coupler may also use the electrified lane together with the vehicle equipped with the coupler. The vehicle without the coupler may take electricity from the coupler.

### Alternative Embodiment B

In another alternative embodiment, a group of vehicles of any type including those powered by conventional internal combustion engine is pulled in a train formation by a tall vehicle equipped with a power pick up means assembly in Alternative Embodiment A. The train is assembled and disassembled at a terminal that is connected to the electrified lane by flyovers. The towed vehicles in this case do not have an account to use the electric highway, and thus the driver of the towed vehicle must pay directly to the operator of the towing vehicle for the towing service.

The towed vehicle will be temporarily furnished with a detachable coupler assembly of the alternative design with power line connectors that include front and rear couplers connected by a metal beam and an onboard lateral location sensor that is connected to the towing vehicle by electric wires for electromechanically controlled brakes and a communications means. The towed vehicle must be equipped with a brake system that can be remotely controlled from the towing vehicle and is equipped with a steering system that can be controlled by an automated steering mechanism which is mounted at the terminal by the system operator, and the vehicle will have to be made ready for affixing the coupler assembly for towing before using this system.

### Hybrid Systems of Different Embodiments

A hybrid system between the preferred embodiment and the Embodiment A is possible. In this hybrid system, large trucks equipped with the mechanical couplers may use only the overhead wires and the pantograph assembly. The overhead wire system and the under the pavement conductor system embodiment may share one system operation monitoring center that operates the entire system, one communication network, and the same magnetic cells and every other roadside posts—the spacing of which posts, for example, may be set up to be about 20 meters in the preferred embodiment and about 40 meters in Alternative Embodiment A. In this case, the roadside post with the camera attached to it may be set up only for that hold the overhead wires.

The invention having been described in detail in accordance with the requirements of the U.S. Patent Statutes, various other changes and modifications will suggest themselves to those skilled in this art. It is intended that such changes and modifications shall fall within the spirit and scope of the invention defined in the appended claims.

1. A vehicle operated on highways
including an electric motor, at least one energy storage means, and at least one coupler for physically coupling said vehicle with at least another one of said vehicle.

2. A vehicle operated on highways as defined on claim 1 wherein
said vehicle includes an on-board part of a lateral location sensor and a lateral position control means wherein
said lateral location sensor estimates deviation of center point of front end of said vehicle from imaginary centerline of said electrified lane, and
said lateral position control means tries to correct said deviation.

3. A vehicle operated on highways as defined in claim 1 wherein
said vehicle includes a longitudinal sensor, and
said vehicle includes a longitudinal position control means.

4. A vehicle operated on highways defined in claim 1 wherein
said coupler couples with another one of said coupler using magnetic force.

5. A vehicle operated on highways as defined in claim 1 wherein
said coupler couples with another one of said coupler using mechanical means.

6. A vehicle operated on highways as defined in claim 1 wherein
said vehicle has a different coupler height depending on a vehicle type.

7. A vehicle operated on highways as defined in claim 1 wherein
said coupler includes a pair of snubber assembly.

8. A vehicle operated on highways as defined in claim 1 wherein
said coupler includes a pair of coupling means.

9. A vehicle operated on highways as defined in claim 8 wherein
said coupling means includes means to generate magnetic field,
two of said couplers couple together by magnetic attraction.

10. A vehicle operated on highways as defined in claim 8 wherein
said coupling means includes a suction cup, and
two of said couplers couple together by suction.

11. A vehicle operated on highways as defined in claim 1 wherein
said coupler has a housing that encloses a coupling hook means and a coupling hook receiving bay disposed side by side, and
said coupling hook means is narrower at the tip, and is pivotably affixed to a pin,
said coupling hook receiving bay is wider at the opening end for easier entry of the hook means of the other said coupler, and has a switch at the farthest end from the opening.

12. A vehicle operated on highways as defined in claim 1 wherein said coupler has connection means for power cables.

13. A vehicle operated on highways as defined in claim 1 wherein said coupler has connection means for a communication cable.

14. A vehicle operated on highways as defined in claim 1 wherein
said highways have at least one electrified lane,
said electrified lane has a pavement surface,
said vehicle includes an on-board power pick up means assembly that includes a power pick up means assembly,
said power pick up means assembly is placed beneath the bottom of said vehicle,
said vehicle is equipped with a means to lift up and down said power pick up means assembly so that said power pick up means assembly can get closer to said pavement surface of said electrified lane when said vehicle is in said electrified lane, and
said power pick up means assembly is equipped with a means for sweeping possible debris on the electrified lane.

15. A vehicle operated on highways as defined in claim 1 wherein
said electrified lane has a pavement surface,
said vehicle includes an on-board power pick up means assembly that includes a power pick up means assembly,
said power pick up means assembly is placed beneath the bottom of said vehicle,
said vehicle is equipped with a means to lift up and down said power pick up means assembly so that said power pick up means assembly can get closer to said pavement surface of said electrified lane when said vehicle is in said electrified lane, and
said power pick up means assembly is equipped with wheels.

16. A vehicle operated on highways
said highways include at least one electrified lane and a roadside subsystem wherein
said roadside subsystem includes a pair of contact wires per said electrified lane,
said vehicle includes a power pick up means assembly,
said power pick up means includes at least a pair of sliding means,
each of said sliding means slidably contacts one of said contact wires,
each of said sliding means affixed to top of each of a pair of carriers made of a non-conductive material,
at least two pairs of horns made of a non-conductive material each of which horn is affixed to each side of said carrier,
said carriers are affixed to a support frame assembly,
a pantograph beam assembly is affixed to said support frame assembly at one end and affixed to the roof of said vehicle at the other end,
said two sliding means have a lateral gap such that even said contact wires fall lower than the normal level by accident, either of said contact wires will not touch both of said sliding means at the same time, and
said two sliding means are generally of the same length, which is shorter than spacing between said two contact wires and thus either of the sliding means will not touch said two contact wires at the same time.

17. A vehicle operated on highways as defined in claim 16 wherein
said vehicle includes at least one coupler, an on-board part of a lateral location sensor and a lateral position control means, and
said vehicle is able to operate in said electrified lane being coupled with at least one of said vehicle in said electrified lane while said vehicle is controlled by said lateral position control means.

18. A vehicle operated on highways as defined in claim 16 wherein
said highways have terminals along said highways, and
said vehicle is coupled or decoupled with said vehicle in said terminal.

19. A vehicle operated on highways as defined in claim 16 wherein
said vehicle includes a longitudinal position control means, and
said vehicle is able to couple and decouple with said vehicle on said highways while said vehicle is controlled automatically by said lateral position control means and said longitudinal position control means.

20. A vehicle operated on highways as defined in claim 16 wherein
said power pick up means assembly of said vehicle is folded down when not in use.
